(19) United States
(12) Patent Application Publication
(10) Pub. No.: US 2004/0193836 A1
(43) Pub. Date: Sep. 30, 2004

(54) Electronic systems comprising a system bus

(75) Inventor: Bernard Ramanadin, Crolles (FR)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(73) Assignee: STMICROELECTRONICS S.A., MONTROUGE (FR)

(21) Appl. No.: 10/701,384

(22) Filed: Nov. 4, 2003

(30) Foreign Application Priority Data
Nov. 4, 2002 (FR) 02 13753

(51) Int. Cl. G06F 15/00

(52) U.S. Cl. 712/1

(57) ABSTRACT

A resynchronization module for use in an electronic system comprising a system bus comprises pipeline means of for pipelining the transactions intended for and/or originating from the associated functional module. The pipeline means comprise a first buffer circuit and at least one second buffer circuit, which are connected in parallel, and are each, adapted for storing transaction data of a specific transaction.

### CROSS-REFERENCE TO RELATED APPLICATIONS

This application is based upon and claims priority from prior French Patent Application No. 02 13753, filed on Nov. 4, 2002 the entire disclosure of which is herein incorporated by reference.

### FIELD OF THE INVENTION

The present invention pertains to electronic systems comprising a system bus, in particular microprocessors and other functional modules coupled to system buses.

### BACKGROUND OF THE INVENTION

In the field of microprocessors, functional modules are connected to the system bus via appropriate communication ports. The expression functional module is intended to mean a module, which makes it possible to provide a specified functionality of the system. In a microprocessor, such functional modules are for example a CPU (Central Processing Unit) core, interfaces allowing access to external resources, etc.

The functional modules exchange transactions via the system bus. The term transaction designates operations initiated by a master functional module and performed by a slave functional module, essentially data writes and reads. The transactions follow relatively long logical paths, which affect the propagation time of the transactions. Now, each functional module, and each communication port of the functional modules, must comply with time relation constraints (timing constraints), which are defined as a percentage of a clock cycle.

Moreover, certain functional modules connected to the bus are slow senders and/or slow receivers. As a result of this, a slave functional module may insert waiting cycles during a transaction. This type of transaction increases the bus occupancy time.

This is why it is desirable to provide means for relaxing the time relation constraints on the bus, when the propagation times are critical, in view of the operating frequency of the system.

To this end, means for pipelining the transactions are known. Such pipelining allows a functional module to send or receive a transaction even though another transaction is currently being transmitted on the bus or executed, respectively.

In the prior art, it is known to insert a FIFO (First-in First-out) type memory structure between a functional module and the system bus, for just one or both directions of communication (send and receive). The transactions pass through this memory structure.

The size of the string must be sufficient to store all the protocol data units (PDU) belonging to the transactions, which are pipelined. Consequently, if one wishes to pipeline a given number P of transactions each spreading over a given number Q of protocol data units, it is necessary to provide a string of P×Q registers in series. As a result, the transactions must systematically pass through P×Q a register, which requires a duration corresponding to P×Q clock pulses. This solution therefore introduces some latency without reducing the bus occupancy time.

This latency is even more penalizing when the transactions are of variable size, that is when they spread over a variable number of protocol data units. For example, for a transaction, which extends over a maximum of four protocol data units, a string of eight registers long is necessary in order to fully store two transactions of maximum size. Now, even transactions, which are shorter, for example ones which contain only a single protocol data unit, must pass through the string of eight registers.

According what is needed is a method and system to over come the problems encountered in the prior art and to involving pipelines with transactions of variable sizes while minimizing the bus occupancy time.

### SUMMARY OF THE INVENTION

The present invention overcomes the problems with the prior art by inserting a resynchronization module (also called a retiming buffer module) between a functional module and the bus. This resynchronization module comprises buffer circuits which can store transaction data of a specified transaction. From the point of view of the protocol of the system bus, such a functional module is transparent. Its sole function is to receive, to store and then to transmit data of a transaction originating from or intended for a functional module with which it is associated.

A first aspect of the invention thus relates to an electronic system comprising a system bus and functional modules which can exchange transactions, including transactions of variable sizes, via the system bus. The system comprises at least one resynchronization module arranged between an associated functional module and the system bus. The resynchronization module comprises means of overlap for overlapping the transactions intended for and/or originating from the associated functional module. The pipeline means comprise a first buffer circuit and at least one second buffer circuit which are connected in parallel and are each adapted for storing transaction data of a specific transaction.

In one embodiment, the pipeline means further comprise:

an input port for receiving an input transaction, the input transaction containing specified transaction data;

first management means for storing the transaction data in the first buffer circuit or in the second buffer circuit if the first buffer circuit is not empty, or for refusing the input transaction if the first buffer circuit and the second buffer circuit are not empty;

second management means for requesting an output transaction as soon as the transaction data are stored, for generating the output transaction from the stored transaction data, and for emptying the buffer circuit containing the transaction data as soon as the second transaction is transmitted; and

an output port for transmitting the output transaction under the control of the second management means.

The first management means may comprise a first state machine and a demultiplexer, which is controlled by the first state machine. Likewise, the second management means may comprise a second state machine and a multiplexer which is controlled by the second state machine.

Preferably, when the transactions are of variable size, the first buffer circuit and/or the second buffer circuit each comprise buffer registers connected in parallel at least equal in number to the maximum number of protocol data units that a transaction can contain. Each of these registers is adapted to store the transaction data of a respective protocol data unit of the transaction. Thus, the transmission time of the transactions having fewer cells than the maximum number of cells that a transaction can contain is not constrained by this maximum number.

The first buffer circuit and/or the second buffer circuit may also comprise a buffer register which is adapted for storing transaction data common to all the protocol data units of the transaction. In this way, the size of the registers which store the protocol data units may be reduced.

In one example, the system further comprises an output buffer register arranged upstream of the output port. This register comprises:

a first register with flip-flops comprising a given number N of flip-flops each having a data input, a data output and an enable input;

a second register with flip-flops comprising N flip-flops, each having a data input, a data output and an enable input;

a third register with flip-flop comprising a flip-flop having a data input, a data output and an enable input;

an output multiplexer having N first inputs, N second inputs, N outputs and a selection input.

The data inputs of the N flip-flops of the first register receive N input signals respectively. The data outputs of the N flip-flops of the first register are respectively linked to the N first inputs of the output multiplexer. The N outputs of the output multiplexer deliver N respective output signals. The data inputs of the N flip-flops of the second register are respectively linked to the N outputs of the output multiplexer. The N data outputs of the N flip-flops of the second register are respectively linked to the N second inputs of the output multiplexer. The data output of the third register is linked to the selection input of the output multiplexer. The data input of the third register receives an enable signal. Finally, the enable inputs of the flip-flops of the first, second and third registers receive one and the same clock signal.

A second aspect of the invention pertains to a resynchronization module intended to be used in a system according to the first aspect. This module comprises pipeline means for pipelining the transactions intended for and/or originating from the associated functional module. The pipeline means comprise a first buffer circuit and at least one second buffer circuit which are connected in parallel, each of which is adapted for storing transaction data.

A third aspect of the invention pertains to a method for managing an electronic system comprising a system bus and functional modules which can exchange transactions of variable size via the system bus. The method comprises the steps of:

providing at least one resynchronization module arranged between an associated functional module and the system bus;

providing in the resynchronization module pipeline means for pipelining the transactions intended for and/or originating from the associated functional module; and

providing in the pipeline means a first buffer and at least one second buffer circuit which are connected in parallel, each of which is adapted for storing transaction data of a given transaction.

A mode of implementation of the method comprises the steps of:

receiving an input transaction, the input transaction containing specified transaction data;

storing the transaction data in the first buffer circuit or in the second buffer circuit if the first buffer circuit is not empty, or for refusing the input transaction if the first buffer circuit and the second buffer circuit are not empty;

requesting an output transaction as soon as the transaction data are stored;

generating the output transaction from the stored transaction data;

emptying the buffer circuit containing the transaction data as soon as the second transaction is transmitted;

transmitting the output transaction via an output port under the control of the second management means.

When the transactions are of variable size, the step of storing the transaction data in the first buffer circuit or in the second buffer circuit preferably comprises the steps of:

providing in each of the first and second buffer circuits buffer registers connected in parallel, in number at least equal to the maximum number of protocol data units that a transaction can contain; and

storing the transaction data of each protocol data unit of the transaction in the respective one of the buffer registers of the buffer circuit.

Moreover, the step of storing the transaction data in the first buffer circuit or in the second buffer circuit may also comprise the steps of:

further providing in each of the first and second buffer circuits an additional buffer register connected in parallel; and

storing in the buffer register the transaction data common to all the protocol data units of the transaction.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention will be apparent from the following detailed description taken in conjunction with the accompanying drawings in which:

FIGS. 1 is a simplified diagram of a microprocessor comprising a system bus;

FIGS. 2 is a chart illustrating the layered organization of the Super Hyway protocol;

FIGS. 3 is a diagram illustrating the connection of an initiator module and of a target module to the Super Hyway bus;

FIGS. 4 shows timing diagrams of signals of the Super Hyway bus during a request with four cells;

FIGS. 5 and FIGS. 6 are diagrams illustrating the layout in a system of the resynchronization modules according to the present invention;

FIGS. 7 is a detailed diagram of an embodiment of a part of a resynchronization module according to the present invention;

FIGS. 8 is a diagram illustrating the principle of an advantageous design rule for a resynchronization module according to the invention;

FIGS. 9 illustrates a first embodiment of an output buffer circuit of an exemplary resynchronization module according to the present invention; and

FIGS. 10 illustrates a second embodiment of an output buffer circuit of an exemplary resynchronization module according to the present invention.

### DESCRIPTION OF THE PREFERRED EMBODIMENTS

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

In the present description of the invention, we consider the example of an electronic system having a bus called “Super Hyway”. This is a system bus for microprocessors having a pipeline architecture. It was designed to operate at 200 MHz. The Super Hyway bus is the spinal cord of the SOC (System on Chip) developed by STMicroelectronics and Hitachi. Of course, the principle of the invention is not however limited to this example.

The Super Hyway bus supports a transactions protocol based on the transmission of packets. This protocol constitutes the highest layer of the communication infrastructure between two functional modules (master and slave) connected to the bus. In the Super Hyway bus terminology, the master modules are called initiators and the slave modules are called targets.

A transaction defines the communication between an initiator port of the initiator module and a target port of the target module. This involves a complete data processing cycle which is executed in response to a query and which in itself constitutes a whole, with a start and an end. The transactions of the Super Hyway protocol are of two types only: requests and responses. However, the protocol is the same in both directions, interrogation and response. Only the name and the number of the signals of the bus which are used are different from one type of transaction to the other. The data of a transaction of the Super Hyway protocol are contained in one or more protocol data units called cells. A transaction can contain one, two or four cells. It is in this sense that it is the to be of variable size. In one example, each cell contains 8 bytes, that is 64 bits.

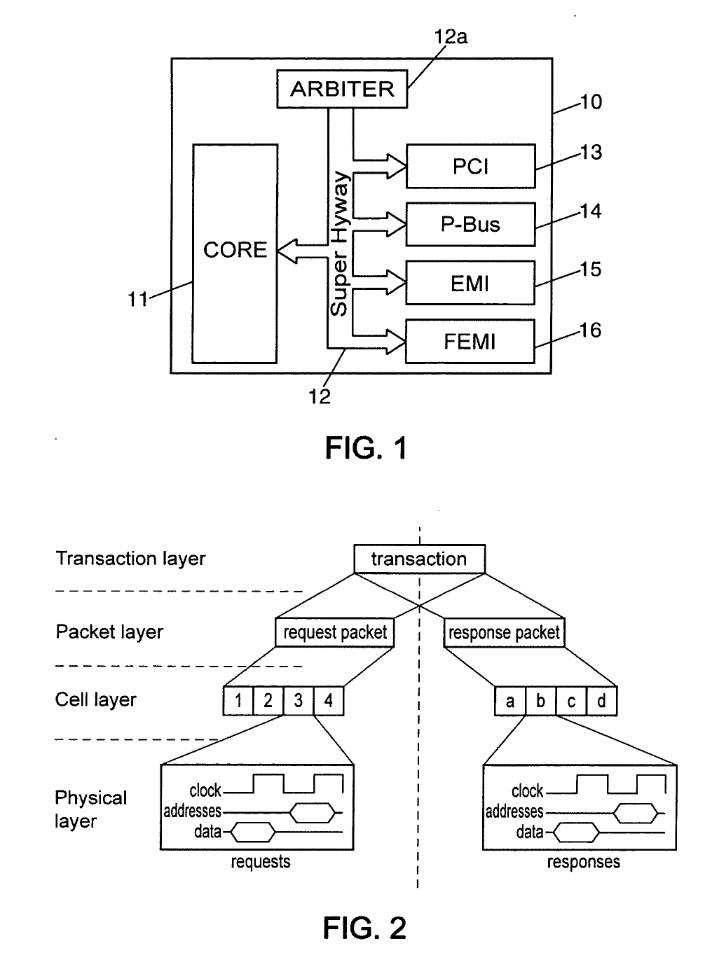

FIGS. 1 gives a diagram of the main elements included in an exemplary electronic system in which the invention can be implemented. This exemplary system is the ST50 microprocessor developed by STMicroelectronics.

The ST50 microprocessor is an evaluation SOC intended for testing and demonstrating the capacities of the SH5 core in a complete system. The SH5 is a CPU (Central Processing Unit) core, the last member of the SuperH family, developed jointly by Hitachi and STMicroelectronics. The ST50 microprocessor was designed to be used in development systems and application platforms for developers and users of the SH5 core.

In the example, the system comprises a core 11, a system bus 12 and functional modules 13 to 16.

The core 11 is the SH5. This is a high-performance, low consumption 64-bit RISC processor of reduced size. It is dedicated to embedded applications, especially in the field of digital television, of telecommunication and the automotive field. This core possesses functionalities adapted to multimedia applications, accessible through its SIMD (Single Instruction Multiple Data) instruction set. An optional floating point unit, in accordance with the IEEE 754 standard, makes it possible for 3D graphical calculations to be performed. The architecture of the instruction set possesses a mode compatible with the ST40, which is the microprocessor of the previous generation, and a native 64-bit mode for high performance or for multimedia modules. Non-intrusive debugging functions render the development of real-time systems possible. These functionalities comprise a real-time traceability mechanism. This core is supplied in the form of an ASIC for implementation in SOCs.

The system bus 12 is a Super Hyway bus. This is a bus clocked at 200 MHz, permitting transfer rates of up to 3.2 Gigabytes/s. It has a width of 64 data bits and is “full duplex”. It supports burst modes of transfer. This allows transfers of 32 bytes per transaction. This bus possesses an arbiter 12a which allocates access to the bus according to the round-robin technique.

A first functional module 13 consists of a PCI (Peripheral Component Interconnect) interface. The PCI interface is 32-bits wide. It permits operating frequencies of 33 and 66 MHz. It makes it possible to address a continuous memory space of 512 Mbytes and accepts up to four masters on the bus. The integration of a PCI interface allows the connection to the ST50 microprocessor of numerous standard peripherals, even before specific blocks are developed for integration with the SOC.

A second functional module 14 comprises a P-Bus (Peripheral Bus) interface, which plays the role of gateway to another bus allowing the extension of the system to peripheral components.

A third functional module 15 comprises a so-called EMI (External Memory Interface) interface. The EMI makes it possible to connect memories of RAM, DRAM or SDRAM type with data buses of 16, 32 or 64 bits, and clock frequencies lying between 66 and 133 MHz. It is possible to use DRAMs of size 16 Mbytes, 64 Mbytes, 128 Mbytes, 256 Mbytes, 512 Mbytes. By virtue of two signals CS (Chip Select), the EMI can address up to 1 Gbyte.

Finally, a fourth functional module 16 comprises a so-called FEMI (Flash EMI) interface. The FEMI makes it possible to connect memories of Flash/ROM type with data buses of 8, 16, 32 bits and an address bus of 26 bits. It allows transfers in synchronous burst and asynchronous burst mode. It supports the MPX protocol and can operate at frequencies of 50, 66 and 100 MHz.

The system comprises other elements, in particular a system clock which regulates the functional modules and the bus, which are not represented in FIGS. 1.

The chart of FIGS. 2 illustrates the layered structure of the communication protocol of the Super Hyway bus. Like numerous network protocols, the Super Hyway protocol is in fact decomposed into layers. It possesses four layers which are the transaction, packet, cell and physical layers.

A transaction defines the communication between two functional modules of the system. This communication can be a simple byte or a complete data structure. For the implementation on the Super Hyway bus, the transactions are chopped into a series of memory operations. The packet layer separates the operations into a request/response pair. At this level, the packets contain a fixed quantity of data that must be rendered compatible with the implementation of the bus. The cell layer therefore breaks the packets into a series of cells, all of which have the right size. Specifically, the size of the bus can vary according to its implementations. In the case of the ST50, the data part of the bus is 64 bits wide. The packets are therefore decomposed into cells of 64 data bits. The physical layer, as its name indicates, carries out the physical encoding of these cells while adding structural and flow control information.

More details regarding each of the layers of the protocol are given below.

### Transaction Layer

A module communicates with the remainder of the system by using standard transactions. These transactions define the operations which can be generated when a module communicates with the system. This typically involves operations in a memory such as reads or writes of various sizes. The transaction comprises all the information required by the system to unambiguously define the operation requested as well as its parameters.

The possible operations are:

the LOAD operation (on M bytes) makes it possible to read an aligned word of M bytes of the target module to the initiator module. The possible values for M are 1, 2, 4, 8, 16, 32;

the STORE operation (on M bytes) makes it possible to write an aligned word of M bytes from the initiator module to the target module. This operation overwrites the previous data item at the specified address. The permitted values of M are 1, 2, 4, 8, 16, 32;

the SWAP operation (on M bytes) exchanges the value of an aligned word of M bytes of the initiator module with the data item stored at the specified location in the target module. The data item which was originally in the target module is returned to the initiator module. The permitted values of M are 4 and 8;

the FLUSH operation returns a response when a copy of the data item, associated with a specified physical address, which ought to be stored in a target module is actually present at the given physical address. The target module then retains a copy of the data;

the PURGE operation returns a response when a copy of the data item, associated with a given physical address, which ought to be stored in a target module is actually present at the specified physical address. The data item is then deleted from the target module.

### Packet Layer

The packet layer separates the transactions into requests and into responses. The systems developed on the basis of the Super Hyway bus are composed of modules of two types only: initiator and target.

The initiator modules initiate the system operations. They control them by despatching an operation and an address. The operations despatched by the initiator modules to a target module are the requests.

The target modules receive the requests and perform the corresponding operations. The result of the operation is sent back to the initiator module by means of another transaction, this being a response.

### Cell Layer

The cell layer splits the packets into subsets compatible with the size of the Super Hyway bus. Specifically, the specifications of the Super Hyway bus do not determine the size of the data bus. Depending on the implementation, it can measure 16, 32 or 64 bits wide. In the case of the ST50, the data bus of the Super Hyway bus measures 64 bits wide.

The cells of a request packet are denoted 1, 2, 3 and 4. The cells of a response packet are denoted a, b, c, and d.

As we saw when describing the various possible transactions on the Super Hyway bus, the number of bytes to be transmitted may be 1, 2, 4, 8, 16 or 32. For operations transmitting 1, 2, 4 or 8 bytes, a single cell is sufficient since it can on its own transmit the 64 data bits. For an operation transferring 16 bytes, two cells are necessary. And for an operation transferring 32 bytes, four cells are necessary. Stated otherwise, the size of the packet (in number of cells) depends on the operation.

### Physical Layer

The interface of the Super Hyway bus consists of a series of signals, in particular of data signals and address signals. The physical layer makes it possible to give these signals the values allowing the cells to be transmitted. The physical layer therefore encodes the cells and adds structural and flow control information.

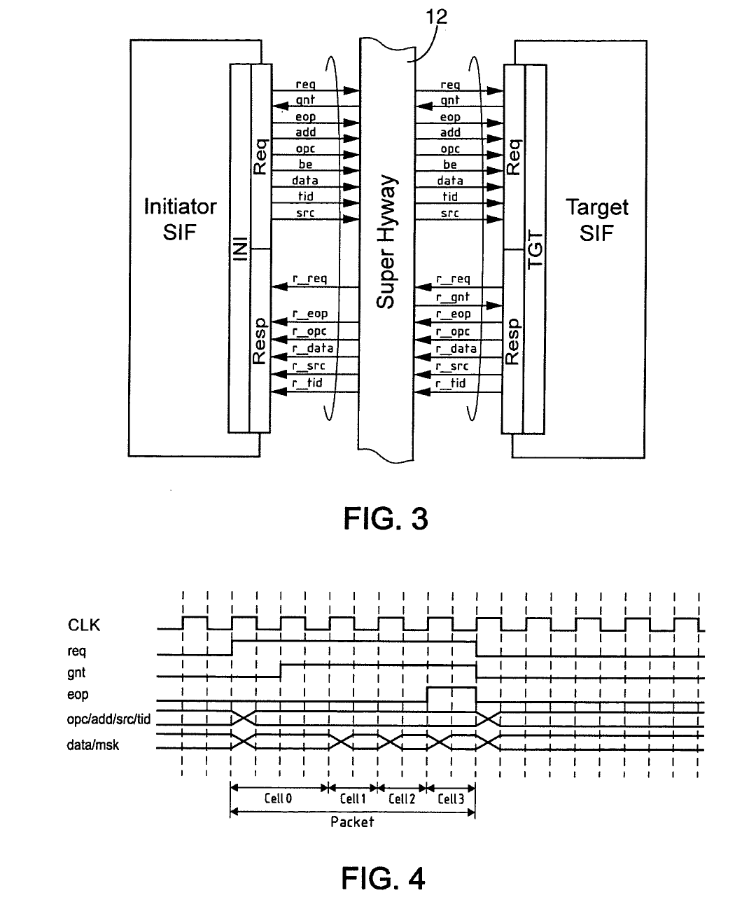

The diagram of FIGS. 3 gives an illustration of the various signals of the Super Hyway 12 bus and their relationship with the initiator module 41 and the target module 42 which are party to the transaction. The signals associated with the request are:

req (request): is active when the initiator module is ready to send the data item;

gnt (grant): is active when the system is ready to receive data from the initiator module;

eop (end of packet): indicates the last cell of the packet;

add[31:3] (address): encode the address of the target of the transaction;

opc[7:0] (opcode): encode the operation associated with the transaction;

src[7:0] (source identity): define the identifier of the source;

tid[7:0] (transaction identity): define the identifier of the transaction;

msk[7:0] (mask) or be[7:0] (byte enable): indicate the valid bytes in the cell; and

data[63:0] (data): encode the data item carried by the cell.

And these are the signals associated with the response:

L_req (response request): is active when the target module is ready to send the data item;

r_gnt (response grant): is active when the system is ready to receive data from the target module;

L_eop (response end of packet): indicates the last cell of the response packet;

r_opc[7:0] (response opcode): encode the response of the target module to the operation;

L_data[63:0] (response data): encode the data item associated with the response cell;

r_tid[7:0] (response identifier): encode a copy of the transaction identifier; and

L_src[7:0] (response source): encode a copy of the source identifier.

In order to give an illustration of the manner of operation of the physical layer of the protocol during an exemplary transaction, the timing diagrams of FIGS. 4 illustrate the state of the signals of the bus during a request with four cells (a priori the most complex).

When an initiator module generates a request, it places the valid information on the bus (data signals, msk, opc, add, tid and eop) and places the req line at 1. The system signals that it is ready to receive the transaction by placing the line gnt at 1. The system (more particularly the arbiter of the Super Hyway bus) then uses the address field to select the target module for which the transaction is bound.

The opcode field indicates which operation is the one associated with the transaction. This field therefore relates to the target module which will have to perform the operation but also to the Super Hyway bus. Specifically, the opcode field indicates the number of cells contained in the packet. The src field carries the identifier of the initiator module which generates the request. The tid field makes it possible to identify the transaction unambiguously.

The opc, add, src, tid fields remain constant throughout a transaction. This is why these fields define what is referred to as a header. The last cell of a packet is signalled by the eop signal. The latter is at 1 when the cell transmitted is the last of the packet. It is always at 0 otherwise.

A request begins when the initiator module places the req line at 1 and terminates when the three signals req, gnt and eop are simultaneously at 1. Once the initiator module has placed the req line at 1, it is obliged to terminate the transaction begun. That is, it will not be able to replace the req line at 0 before the condition eop=gnt=req=1 has been encountered. Likewise, when the gnt line has been placed at 1, the system must be able to receive the entire transaction. That is, it will not be able to replace the gnt line at 0 before the condition eop=gnt=req=1 has been encountered.

The timing diagrams illustrating a request with one cell and a request with two cells are easily deduced from the foregoing. Likewise, the response transactions comply with the same rules. It is simply necessary to replace req par r_req, gnt by r_gnt, eop by r_eop, opc by r_opc, tid by r_tid and data by r_data. It should be noted furthermore that the msk (or be) and add signals have no equivalent since they are not used for the response.

A slow sender functional module may need time between the sending of two cells of one and the same packet. In this case, it inserts a waiting cycle by temporarily taking the req signal (for an SIF initiator) or the r_req signal (for an SIF target) to 0. For the duration of this cycle, the other signals are maintained at their respective levels.

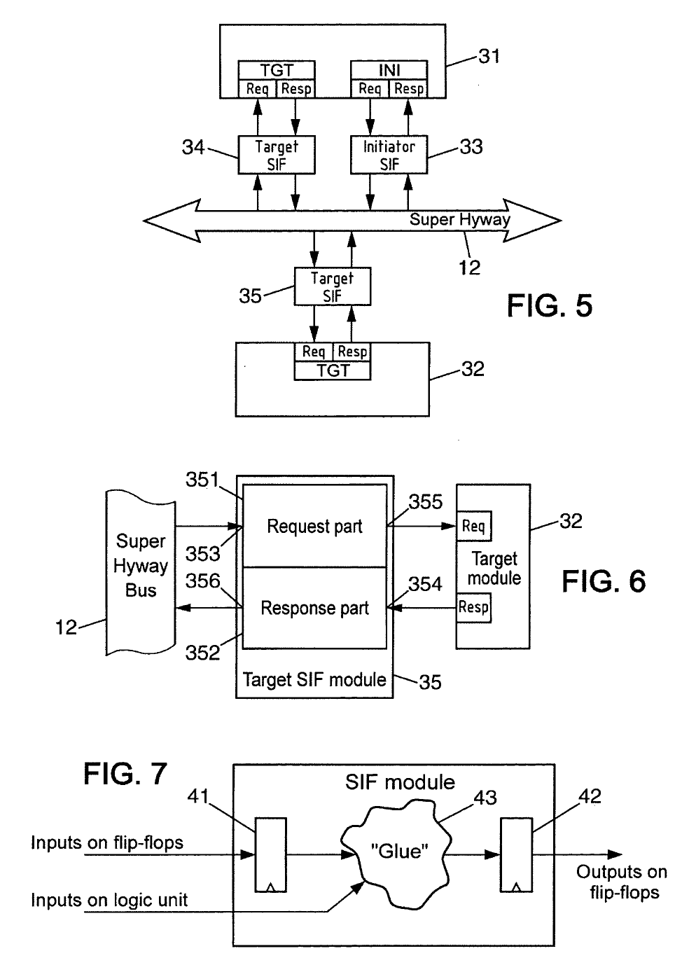

The diagram of FIGS. 5 illustrates the detail of the connection of functional modules to the system bus according to an exemplary implementation of the invention. A functional module 31 of a first type comprises at least one initiator port INI and at least one target port TGT. Stated otherwise, the functional module 31 can be initiator or target, depending on the transaction concerned. Another functional module 32 of a second type comprises only one or more target ports TGT. Other functional modules may also be connected to the bus 12. It will be noted that a third type of functional module (not represented) may have only one or more initiator ports INI. Each port INI or TGT in fact comprises two ports: one Req for sending requests, and the other Resp for receiving responses.

It will be noted that, in the exemplary system described above with regard to FIGS. 2, all the functional modules 11 to 16 are of the first aforesaid type.

In order to loosen the time relation constraints, there is provision to arrange resynchronization modules between some at least of the functional modules and the system bus. These resynchronization modules are called SIFs (SuperHyway InterFace). The role of these SIFs is to break the long combinatorial path going from the initiator port to the target port of the functional modules which are party to a given transaction. To do this, it comprises means for pipelining the transaction. Stated otherwise, they have a buffer function in respect of transactions.

As the initiator ports and the target ports are different, it is preferable to provide two types of resynchronization module, one for each type of port. In this case, there is an initiator SIF and a target SIF. The SIFs are intended to be inserted around the Super Hyway bus, each between an associated functional module and the bus.

In the example represented in FIGS. 5, an initiator SIF 33 is thus arranged between the INI port of the initiator module 31 and the bus 12. Likewise, two target SIFs 34 and 35 are arranged between the TGT ports of the target modules 31 and 32 respectively on the one hand, and the bus 12 on the other hand. The module 31 in fact possesses both an initiator port and a target port.

However, as a variant, it is possible to create a single type of SIF of more complex structure, which is adapted to be associated either with an initiator module or with a target module.

By virtue of the SIFs, the data flow of a transaction between an initiator module and a target module is decomposed into several intermediate data flows: a first intermediate flow between the initiator module and the initiator SIF with which it is associated; a second intermediate flow between the initiator SIF and the target SIF, via the bus 12; and finally a third intermediate flow between the target SIF and the target module with which it is associated.

It will be noted that, when only the initiator module is linked to the bus via an initiator SIF, the target module being linked directly to the bus, the second intermediate flow does not exist. The third intermediate flow (which is in fact the second) then takes place between the initiator SIF and the target port, via the bus 12.

Conversely, when only the target module is linked to the bus via a target SIF, the initiator module being linked directly to the bus, the second intermediate flow does not exist. The first intermediate flow then takes place between the initiator module and the target SIF, via the bus 12. Also, the third intermediate flow (which is in fact the second) takes place between the target SIF and the target module.

It will be noted that the intermediate data flows between an SIF and the functional module with which it is associated obey the rules of the lowest layer (i.e. the physical layer) of the protocol of the system bus. In this way, the presence of the SIF is completely transparent to the functional module with which it is associated, to the other functional modules, and to the bus. In particular, the functional module associated with an SIF remains accessible by the remainder of the system via its own address, the SIF having no address but being connected physically between the functional module and the bus.

In one exemplary implementation, each SIF module comprises two main blocks, a request block for transmitting the requests which come from the initiator module and a response block for transmitting the responses which come from the target module. Stated otherwise, the SIFs process the data at the level of the packet layer of the protocol.

By way of example, FIGS. 6 shows the detail of the layout of the target SIF 35 between the Super Hyway 12 bus and the target module 32 of FIGS. 3. A request block 351 of the target SIF 35 accepts or refuses a request coming from an initiator module (not represented) across the bus 12. If it accepts, it receives on an input port 353 the request coming from the bus 12, stores the request data in a buffer structure, then sends them on an output portion 355 to the Req port of the target module 32 when a request issued by the target SIF 35 and intended for the target module 32 is accepted by the system. Conversely, a response block 352 accepts or refuses a response coming from the target module 32 with which it is associated. If it accepts, it receives on an input port 354 the response coming from the Resp port of the target module 32, stores the response data in a buffer structure, then sends them on an output port 356 to the bus 12 when a response requested by the target SIF module 35 and intended for the initiator module (not represented) is accepted by the system.

The micro-architecture of the SIFs will now be described. Let us turn, beforehand, to FIGS. 7 which illustrates an advantageous design rule for producing the micro-structure of the SIFs.

According to this rule, one ensures that a maximum of input signals are received on the respective data inputs of an input register 41. Moreover, one ensures that a minimum of input signals are received on control inputs of synchronous elements forming a combinatorial logic unit 43 (“Glue” to use the jargon of the person of average skill in the art). Finally, one ensures that all the output signals are delivered on the respective data outputs of an output register 42. In one example, the input and output registers are D type flip-flop registers. The rule then prescribes that the micro-architecture of the SIF be designed in such a way that a maximum of input signals arrives on D inputs and that all the output signals are delivered by Q outputs of such flip-flops. The initiator and target SIFs being very similar, the case of a target SIF only is considered here. The following account is nevertheless also valid for an initiator SIF, given the necessary alterations, which are within the scope of the person of average skill in the art. It is sufficient to recall that an initiator SIF receives requests and delivers responses, respectively from and to the initiator module with which it is associated, whereas the reverse holds for a target SIF: it receives responses and delivers requests respectively from and to the target module with which it is associated. Moreover, the protocol is identical for requests and responses, only the name and the number of signals of the bus which intervene are different. The micro-architecture of the response block of an SIF is therefore very similar to that of the request block of this SIF.

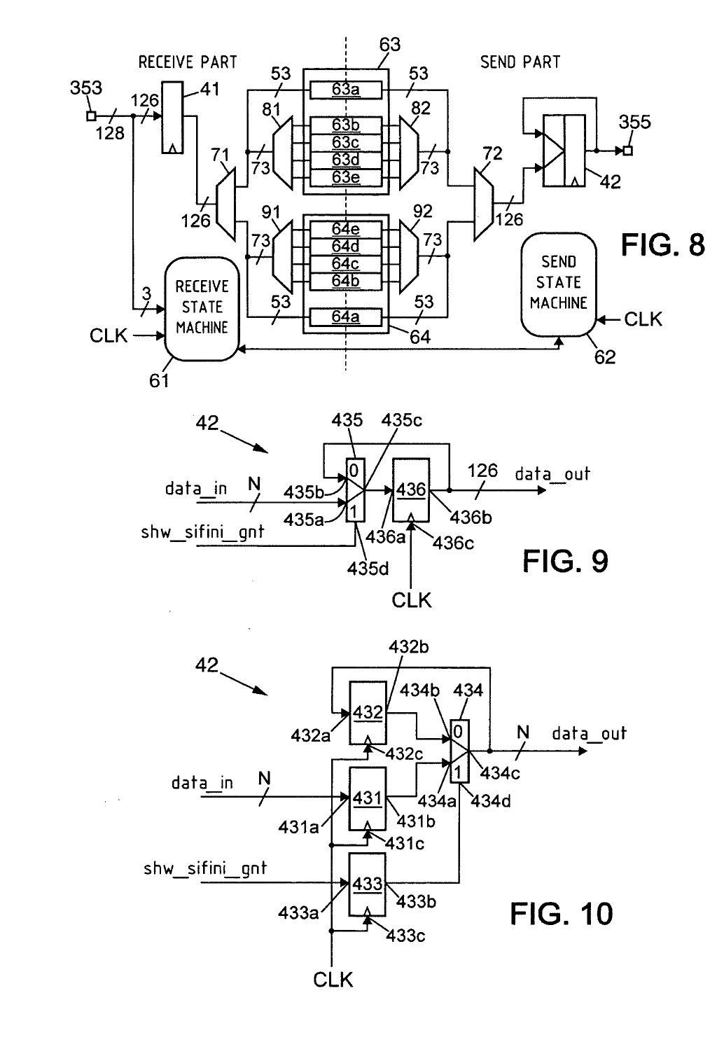

This is why, by way of example, the diagram of FIGS. 8 shows the micro-architecture of the request block of a target SIF.

The micro-architecture of each block is decomposed into a receive part and a send part. The receive part of the request block manages the reception and storage of the requests coming from the Super Hyway bus. The send part of the request block manages the resending of the stored request data to the associated target module. Each of the two parts is controlled by a state machine, 61 and 62 respectively. In FIGS. 8, the zone controlled by a state machine is delimited by a dashed vertical line, the receive part and the send part being represented on the left and on the right respectively of this line.

For example, the state machines are state machines with synchronized outputs. This makes it possible to give margins for the time relation constraints. These may be state machines of the Moore type or of the Mealy type. The control signals delivered by the state machines are not represented so as not to overburden the diagram.

The input port 353 receives the signals from the bus 12 which were presented above with regard to the diagram of FIGS. 3. For the sake of clarity, the signals are represented in FIGS. 8 by a single dash corresponding to 128 bus lines.

In accordance with the design rule presented above with regard to the diagram of FIGS. 7, the receive part comprises an input register 41, comprising flip-flops for receiving 126 data bits which are apportioned as follows: one data bit which is carried by the eop signal, 28 data bits carried by the signal add[31:3], 8 data bits carried by the signal opc[7:0], 8 data bits carried by the signal src[7:0], 8 data bits carried by the signal and tid[7:0], 8 data bits carried by the signal msk[7:0] (or be[7:0]), and 64 data bits of a respective one of the four cells (at most) of the transaction which are carried by the signal data[63:0].

Likewise, the send part comprises an output register 42 comprising flip-flops for delivering the 128 data bits of the request. Two embodiments of the output register 42 will be described later with regard to the diagrams of FIGS. 9 and 10, respectively.

The state machine 61 receives the signals req, gnt and eop, totalling 3 lines. Moreover, the state machine 61 and the state machine 62 receive the clock signal CLK which is the signal of the system clock (whose maximum frequency is equal to 200 MHz). Thus, each state machine is synchronous with the system clock.

The SIF module contains two buffer circuits 63 and 64. Each of the buffer circuits 63 and 64 is adapted for storing the transaction data of a given transaction. In particular they each comprise a header register 63a and 64a respectively, comprising flip-flops for storing the 53 data bits carried by the header signals add[31:3], opc[7:0], src[7:0], tid[7:0] and eop. Moreover, they each comprise four cell registers 63b to 63e and 64b to 64e respectively. Each cell register comprises flip-flops for storing 73 data bits which decompose as follows: 64 data bits of a respective one of the 4 cells (at most) of the transaction which are carried by the signal data[63:0], 8 data bits which are carried by the signal msk[7:0] (or be[7:0]), and a data bit which is carried by the signal eop.

To summarize, each buffer circuit can store 4 cells plus the header of the transaction which remains constant throughout the transaction. Of course, the number of registers of the buffer circuit, and their size, depend on the implementation of the bus. Here there are four cell registers since a transaction can contain at most four cells. However, this is merely an example.

Of course, it is possible to provide more than two buffer circuits such as circuits 63 and 64, in order to pipeline more than two transactions. In the application considered here, it was judged that the greater complexity of the micro-structure which results therefrom, was not justified given the observed effects on the propagation time of the transactions.

The receive part comprises a demultiplexer 71 which receives as input the 126 output bits of the input register 41 and directs them either towards the buffer circuit 63 or towards the buffer circuit 64, under the control of the state machine 61. In the first case, another demultiplexer 81 with four outputs makes it possible to direct the (at most) four cells of a packet which are received in succession, towards one of the registers 63b to 63e of the buffer circuit 63. Likewise, in the second case, another demultiplexer 91 with four outputs makes it possible to direct the (at most) four cells of another packet which are received in succession, towards one of the registers 64b to 64e of the buffer circuit 64.

The input register 41, the demultiplexers 71, 81 and 91, and the buffer circuits 63 and 64 are driven synchronously by the state machine 61 of the receive part.

The send part comprises a multiplexer 72 for directing towards the output register 42, either the transaction data stored in the buffer circuit 63 or those stored in the buffer circuit 64, under the control of the state machine 62. In the first case, the (at most) four cells of a packet which are stored in the registers 63b to 63e of the buffer circuit 63 are directed in succession towards the multiplexer 72 with the aid of a multiplexer 82 with four inputs. Likewise, in the second case, the (at most) four cells of a packet which are stored in the registers 64b to 64e of the buffer circuit 64 are directed in succession towards the multiplexer 72 with the aid of a multiplexer 92 with four inputs.

The buffer circuits 63 and 64, the multiplexers 72, 82 and 92 and the output register 42 are driven synchronously by the state machine 62 of the receive part. By having two buffer circuits (here in the request block), it is possible for the SIF to overlap the transactions (here the requests).

The manner of operation of the request block of the target SIF is as follows. When the SIF accepts a first transaction (request), the data of the transaction are stored in a first of the buffer circuits which is empty. The SIF then asks the functional module (target) with which it is associated for a transaction (request) as soon as possible. When this transaction is accepted, the transaction data are read from the first buffer circuit so as to be sent to the target module associated with the SIF. The first buffer circuit is then emptied. During this time, a second transaction can be accepted by the SIF and the corresponding transaction data are stored in the second buffer circuit which is empty. As soon as possible (in particular as soon as the transaction which it has requested is terminated, if it is in progress), the SIF asks the associated functional module (target) for a second transaction so as to send the transaction data stored in the second buffer circuit and to be able to empty the latter.

The two state machines communicate with one another to indicate which buffer circuit is ready to be read or which one has just been emptied and can again store transaction data. It will be noted that if the two buffer circuits 63 and 64 are non-empty, the SIF refuses the transaction if it receives one. It is recalled that it is possible to increase the number of buffer circuits beyond two, so as to be able to store transaction data of more than two transactions at one and the same time.

It may be noted that this micro-architecture adheres to one of the constraints defined at the start of the project. Specifically, a maximum of inputs is on D inputs of flip-flops (those of the input register 41). Only the input signals which arrive directly at the state machine 61 (namely the signals req, gnt and eop in the example) pass through the combinatorial logic unit. These are flow control signals. It is not in fact possible to shift them by a clock pulse and hence to make them pass through a register.

Two exemplary embodiments of the output register 42 which is arranged upstream of the output port 355 will now be described. For the sake of generality, this register is considered to transmit a given number N of signals. In the example, N is equal to 126.

In a conventional embodiment, represented diagrammatically in FIGS. 9, the output register 42 comprises a single register with flip-flops 436, and an input multiplexer 435. The flip-flops are, for example, D type flip-flops.

The output buffer register comprises a single register with flip-flops 436 or input register, and an input multiplexer 435.

The register 436 comprises N flip-flops, each having a data input, a data output and an enable input. The multiplexer 435 comprises N first inputs 435a, N second inputs 435b, N outputs 435c and a selection input 435d.

The N inputs 435a of the multiplexer respectively receive the N input signals data_in, which are the data delivered by the output of the multiplexer 72. The N outputs 435c of the multiplexer are respectively linked to the N data inputs of the register 436. The N data outputs 436b of the respective flip-flops of the register 436 deliver N output signals data_out, respectively. These N output signals are further delivered on the N inputs 435b of the multiplexer 435.

The N enable inputs 436c of the respective flip-flops of the register 436 receive a clock signal CLK. Further, a signal shw_sifini_gnt is received on the selection input 435d of the multiplexer 435. This signal is an enable signal which is for example delivered by a state machine.

The register 436 in combination with the multiplexer 435 makes it possible to latch the values of the output signals when the signal shw_sifini_gnt is at 0.

This prior art adheres to the aforesaid design rule, since the output signals are delivered by data outputs of flip-flops.

On the other hand, the signal shw_sifini_gnt drives N enable inputs, namely the inputs 435d of the N flip-flops of the multiplexer 435. This often requires the introduction of what is called a “buffer tree”, which increases the intricacy of the micro-structure and introduces some latency at the input of the buffer register.

FIGS. 10 shows a preferred embodiment of the output register 42, comprising three flip-flop registers and an output multiplexer. The flip-flops are for example D type flip-flops.

The register 42 thus comprises a first flip-flop register 431 or data input register. The register 431 comprises N flip-flops each having a data input, a data output and an enable input. The N data inputs 431a of the N flip-flops respectively receive the N input signals data_in. The N data outputs 431b of the N flip-flops are linked to N first respective inputs 434a of an output multiplexer 434, having N first inputs 434a, N second inputs 434b, N outputs 434c and a selection input 434d. The N outputs 434c of the output multiplexer 434 deliver the N output signals data_out.

The register 42 further comprises a second flip-flop register 432 or latching register. The register 432 also has N flip-flops, each having a data input, a data output and an enable input. The N data inputs 432a of the N flip-flops of the register 432 are respectively linked to the N outputs 434b of the output multiplexer 434, so as respectively to receive the N output signals. Moreover, the N data outputs of the flip-flops of the register 432 are respectively linked to the N second inputs of the output multiplexer 434.

The register 42 further comprises a third flip-flop register 433 or enable register. The register 433 comprises a flip-flop which has a data input 433a, a data output 433b and an enable input 433c. The data input 433a receives the enable signal shw_sifini_gnt delivered by a state machine forming part of the combinatorial logic unit 43. The data output 433b is linked to the selection input of the output multiplexer 434.

The enable inputs 431c, 432c and 433c of the respective flip-flops of the registers 431, 432 and 433, respectively receive the signal CLK, that is the system clock signal.

The manner of operation of the output buffer register 42 of FIGS. 3 is as follows.

Let us assume that at a given instant, the signal shw_sifini_gnt switches from 0 to 1. At the next clock pulse, the value 1 is stored in the enable register 433. Further, the current values of the N input signals are stored in the input register 432. The N first inputs 434a of the output multiplexer 434 are selected by the signal delivered by the data output 433b of the register 433. Consequently the current values of the N input signals are delivered by the N outputs 434c of the multiplexer 434 as the N output signals, this being irrespective of the previous values of the output signals which were stored in the register 432. At the next clock pulse, the new values of the N output signals are stored in the latching register 432.

Let us now assume that the signal shw_sifini_gnt switches back to zero. At the next clock pulse, the value 0 is stored in the enable register 433. The second inputs 434b of the multiplexer 434 are therefore selected. Consequently, the values of the N output signals, which were previously stored in the latching register 432, are delivered by the N outputs of the multiplexer 434 as the N output signals, this being irrespective of the (possibly new) values of the N input signals. Stated otherwise, the values of the N output signals are latched by the latching register 432.

The aforesaid drawback of the embodiment in FIGS. 9 does not exist with the embodiment of FIGS. 10. Specifically, the signal shw_sifini_gnt enters on the data input of the flip-flop 433 only. Consequently, this embodiment is preferable for high values of N (typically for N greater than 10).

Certainly the embodiment of FIGS. 10 requires 2N+1 flip-flops whereas that of FIGS. 10 comprises only N. When N is large, this amounts to doubling the number of flip-flops, this having consequences for the area of silicon occupied by the SIF.

Moreover, the embodiment of FIGS. 10 does not adhere to the design rule presented above with regard to FIGS. 6, since the output signals are delivered by an output multiplexer. This introduces some latency at output. Nevertheless, this latency is acceptable having regard to the time saving at the input of the register 42.

In a general manner, the insertion of several layers of registers into the SIFs adds some latency into the transactions. However, the time of occupancy of the Super Hyway bus by the SIFs which are connected thereto, this time being managed by the arbiter 12a of the bus, is reduced to its minimum. As a result, overall, the operation of the system is accelerated.

In practice, the implementation of the invention has allowed a synthesis of the Super Hyway bus at 266 MHz. This is a frequency at which, without the implementation of the invention, the system could not possibly operate.

Although a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. An electronic system comprising a system bus and functional modules which can exchange transactions via the system bus, the electronic system comprising:
at least one resynchronization module arranged between an associated functional module and a system bus, the resynchronization module comprising pipeline means for pipelining the transactions intended for and/or originating from the associated functional module, and in that the pipeline means comprises a first buffer circuit and at least one second buffer circuit which are connected in parallel and each of the first buffer circuit and the second buffer circuit adapted for storing transaction data of a specific transaction.

2. The electronic system according to claim 1, wherein the pipeline means further comprises:
an input port for receiving an input transaction, the input transaction containing given transaction data;
first management means for storing the transaction data in at least one of the first buffer circuit and in the second buffer circuit if the first buffer circuit is not empty, and for refusing the input transaction if the first buffer circuit and the second buffer circuit are not empty;
second management means for requesting an output transaction as soon as the transaction data is stored, and for generating the output transaction from the stored transaction data, and for emptying the buffer circuit containing the transaction data as soon as the second transaction is transmitted; and
an output port for transmitting the output transaction under the control of the second management means.

3. The electronic system according to claim 2, wherein the transactions being of variable size, at least one of the first buffer circuit and the second buffer circuit each comprise buffer registers connected in parallel at least equal in number to the maximum number of protocol data units that a transaction contains, each of these registers being adapted to store the transaction data of a respective protocol data unit of the transaction.

4. The electronic system according to claim 3, wherein at least one of the first buffer circuit and the second buffer circuit further comprises a buffer register which is adapted for storing transaction data common to each respective protocol data unit of the transaction.

5. The electronic system according to claim 2, characterized in that the first management means comprises a first state machine and a demultiplexer, which is controlled by the first state machine.

6. The electronic system according to claim 2, characterized in that the second management means comprises a second state machine and a multiplexer which is controlled by the second state machine.

7. The electronic system according to claim 2, characterized in that it further comprises an output buffer register arranged upstream of the output port, and which comprises:
a first register with flip-flops comprising a given number N of flip-flops each having a data input, a data output and an enable input;
a second register with flip-flop comprising a flip-flop having a data input, a data output and an enable input;
a third register with flip-flop comprising a flip-flop having a data input, a data output and an enable input;
an output multiplexer having N first inputs, N second inputs, N outputs and a selection input;
and in which:
the data inputs of the N flip-flops of the first register receive N input signals respectively;
the data outputs of the N flip-flops of the first register are respectively linked to the N first inputs of the output multiplexer;
the N outputs of the output multiplexer deliver N respective output signals;
the data inputs of the N flip-flops of the second register are respectively linked to the N outputs of the output multiplexer;
the N data outputs of the N flip-flops of the second register are respectively linked to the N second inputs of the output multiplexer;
the data output of the third register is linked to the selection input of the output multiplexer;
the data input of the third register receives an enable signal; and
the enable inputs of the flip-flops of the first, second and third registers receive one and the same clock signal.

8. The electronic system according to claim 2, wherein the pipeline means pipelining the transactions intended for and/or originating from the associated functional module, and in that the pipeline means comprises the first buffer circuit and at least one second buffer circuit which are connected in parallel, and are each adapted for storing transaction data of a specific transaction.

9. The electronic system according to claim 7, wherein the pipeline means pipelining the transactions intended for and/or originating from the associated functional module, and in that the pipeline means comprises the first buffer circuit and at least one second buffer circuit which are connected in parallel, and are each adapted for storing transaction data of a specific transaction.

10. The electronic system according to claim 8, wherein the pipeline means comprises:
an input port for receiving an input transaction, the input transaction containing given transaction data;
first management means for storing the transaction data in the first buffer circuit and in the second buffer circuit if the first buffer circuit is not empty, or for refusing the input transaction if the first buffer circuit and the second buffer circuit are not empty;
second management means for requesting an output transaction as soon as the transaction data are stored, for generating the output transaction from the stored transaction data, and for emptying the buffer circuit containing the transaction data as soon as the second transaction is transmitted; and
an output port for transmitting the output transaction under the control of the second management means.

11. The electronic system according to claim 9, wherein the pipeline means comprises:
the input port for receiving the input transaction, the input transaction containing given transaction data;
first management means for storing the transaction data in at least one of the first buffer circuit and in the second buffer circuit if the first buffer circuit is not empty, or for refusing the input transaction if the first buffer circuit and the second buffer circuit are not empty;
second management means for requesting an output transaction as soon as the transaction data are stored, for generating the output transaction from the stored transaction data, and for emptying the buffer circuit containing the transaction data as soon as the second transaction is transmitted; and
an output port for transmitting the output transaction under the control of the second management means.

12. The electronic system according to claim 8, wherein the transactions being of variable size, at least one of the first buffer circuit and/or the second buffer circuit each comprise buffer registers connected in parallel at least equal in number to the maximum number of protocol data units that a transaction can contain, each of these registers being adapted to store the transaction data of a respective protocol data unit of the transaction.

13. The electronic system according to claim 9, wherein the transactions being of variable size, at least one of the first buffer circuit and the second buffer circuit each comprise buffer registers connected in parallel at least equal in number to the maximum number of protocol data units that a transaction can contain, each of these registers being adapted to store the transaction data of a respective protocol data unit of the transaction.

14. The electronic system according to claim 8, wherein at least one of the first buffer circuit and the second buffer circuit further comprise an additional buffer register which is adapted for storing transaction data common to all the protocol data units of the transaction.

15. The electronic system according to claim 9, wherein at least one of the first buffer circuit and the second buffer circuit further comprise an additional buffer register which is adapted for storing transaction data common to all the protocol data units of the transaction.

16. The electronic system according to claim 8, wherein the first management means comprises a first state machine and a demultiplexer, which is controlled by the first state machine.

17. The electronic system according to claim 9, wherein the first management means comprise a first state machine and a demultiplexer, which is controlled by the first state machine.

18. The electronic system according to claim 8, characterized in that the second management means comprise a second state machine and a multiplexer which is controlled by the second state machine.

19. The electronic system according to claim 9, characterized in that the second management means comprise a second state machine and a multiplexer which is controlled by the second state machine.

20. The electronic system according to claim 8, further comprising an output buffer register arranged upstream of the output port, and which comprises:
a first register with flip-flops comprising a specified number N of flip-flops each having a data input, a data output and an enable input;
a second register with flip-flops comprising N flip-flops, each having a data input, a data output and an enable input;
a third register with flip-flop comprising a flip-flop having a data input, a data output and an enable input;
an output multiplexer having N first inputs, N second inputs, N outputs and a selection input;
and in which:
the data inputs of the N flip-flops of the first register receive N input signals respectively;
the data outputs of the N flip-flops of the first register are respectively linked to the N first inputs of the output multiplexer;
the N outputs of the output multiplexer deliver N respective output signals;
the data inputs of the N flip-flops of the second register are respectively linked to the N outputs of the output multiplexer;
the N data outputs of the N flip-flops of the second register are respectively linked to the N second inputs of the output multiplexer;
the data output of the third register is linked to the selection input of the output multiplexer;
the data input of the third register receives an enable signal; and
the enable inputs of the flip-flops of the first, second and third registers receive one and the same clock signal.

21. The electronic system according to claim 9, further comprising an output buffer register arranged upstream of the output port, and which comprises:
a first register with flip-flops comprising a specified number N of flip-flops each having a data input, a data output and an enable input;
a second register with flip-flops comprising N flip-flops, each having a data input, a data output and an enable input;
a third register with flip-flop comprising a flip-flop having a data input, a data output and an enable input;
an output multiplexer having N first inputs, N second inputs, N outputs and a selection input;
and in which:
the data inputs of the N flip-flops of the first register receive N input signals respectively;
the data outputs of the N flip-flops of the first register are respectively linked to the N first inputs of the output multiplexer;
the N outputs of the output multiplexer deliver N respective output signals;
the data inputs of the N flip-flops of the second register are respectively linked to the N outputs of the output multiplexer;
the N data outputs of the N flip-flops of the second register are respectively linked to the N second inputs of the output multiplexer;
the data output of the third register is linked to the selection input of the output multiplexer;
the data input of the third register receives an enable signal; and
the enable inputs of the flip-flops of the first, second and third registers receive one and the same clock signal.

22. A method for managing an electronic system comprising a system bus and functional modules which can exchange transactions of variable size via the system bus, the method comprising:
providing at least one resynchronization module arranged between an associated functional module and the system bus;
providing in the resynchronization module pipeline means for pipelining the transactions intended for and/or originating from the associated functional module; and
providing in the pipeline means of overlap a first buffer circuit and at least one second buffer circuit which are connected in parallel, and are each adapted for storing transaction data of a specific transaction.

23. The method according to claim 22, further comprising:
receiving an input transaction, the input transaction containing given transaction data;
storing the transaction data in the first buffer circuit or in the second buffer circuit if the first buffer circuit is not empty, or for refusing the input transaction if the first buffer circuit and the second buffer circuit are not empty;
requesting an output transaction as soon as the transaction data are stored;
generating the output transaction from the stored transaction data;
emptying the buffer circuit containing the transaction data as soon as the second transaction is transmitted; and
transmitting the output transaction via an output port under the control of the second management means.

24. The method according to claim 22, wherein the storing the transaction data in the first buffer circuit or in the second buffer circuit comprises:
providing in each of the first and second buffer circuits buffer registers connected in parallel, in number at least equal to the maximum number of protocol data units that a transaction can contain; and
storing the transaction data of each protocol data unit of the transaction in the respective one of the buffer registers of the buffer circuit.

25. The method according to claim 24, wherein the storing the transaction data in the first buffer circuit or in the second buffer circuit comprises:
further providing in each of the first and second buffer circuits an additional buffer register connected in parallel; and
storing in the buffer register the transaction data common to all the protocol data units of the transaction.
